(19) United States
(12) Patent Application Publication
(10) Pub. No.: US 2026/0358509 A1
(43) Pub. Date: Nov. 12, 2026

(54) SATELLITE PAYLOADS AND METHODS OF OPERATING SAME

(71) Applicant: European Space Agency, Paris (FR)

(72) Inventors: Lionel Ries, Noordwijk (NL); Florin-Catalin Grec, Noordwijk (NL); Miguel Cordero-Limon, Noordwijk (NL); Marco Anghileri, Noordwijk (NL); Felix Abel, Noordwijk (NL); Roberto Prieto Cerdeira, Noordwijk (NL)

(21) Appl. No.: 19/100,275

(22) PCT Filed: Aug. 1, 2023
(86) PCT No.: PCT/EP2023/071345

§ 371 Date: Jan. 31, 2025

(30) Foreign Application Priority Data
Aug. 1, 2022 (EP) 22188118.8
Aug. 1, 2022 (EP) 22188121.2
Aug. 1, 2022 (EP) 22188123.8

(51) Int. Cl. G01S 19/33; G01S 19/24

(52) U.S. Cl. CPC G01S 19/33; G01S 19/24

(57) ABSTRACT

A method of operating a payload with receive and transmit capabilities in Earth orbit includes receiving Global Navigation Satellite Systems (GNSS) signal(s) from a GNSS in a GNSS frequency band- and transmitting a navigation signal in the GNSS frequency band towards Earth. Therein, the receiving and transmitting are performed in a time division duplex (TDD) mode, with alternating time slots for receiving the GNSS signal(s) and transmitting the navigation signal. The application further relates to corresponding satellite payloads and satellites including such satellite payloads.

### BACKGROUND

### Technical Field

This application relates to the field of satellite communication and space-based positioning. In particular, the application relates to methods of operating satellite payloads with receive and transmit capabilities, to corresponding satellite payloads, and to satellites comprising such satellite payloads.

### Description of the Related Art

Conventional Global Navigation Satellite Systems (GNSS) may suffer from issues such as limited visibility of a sufficient number of GNSS satellites from a user terminal and low Signal-to-Noise Ratio (SNR) of GNSS signals at the location of the user terminal, for example due to low power of GNSS signals when arriving on ground and/or interference from ground-based emissions in GNSS frequency bands.

Thus, there is a need for improved techniques for positioning. There is particular need for such techniques that improve availability and/or accuracy of positioning.

### BRIEF SUMMARY

In view of some or all of these needs, the present disclosure proposes a method operating a payload with receive and transmit capabilities in Earth orbit (e.g., a navigation or positioning method), a payload, and a satellite, having the features of the respective independent claims.

An aspect of the disclosure relates to a method of operating a payload (e.g., satellite payload, satellite navigation payload) with receive and transmit capabilities in Earth orbit. The method may include receiving a GNSS signal from a GNSS in a GNSS frequency band. The method may further include transmitting a navigation signal in the GNSS frequency band towards Earth. The navigation signal may be based, at least in part, on the received GNSS signal(s). The receiving and transmitting may be performed in a time division duplex (TDD), mode, with alternating time slots for receiving the GNSS signal(s) and transmitting the navigation signal. Further, the receiving and/or transmitting may be performed in two or more GNSS frequency bands. Additional transmission may be performed in a non-GNSS frequency band. Here, it is understood that the term GNSS signal may cover any higher-orbit satellite navigation or augmentation signal (e.g., satellite-based augmentation systems (SBAS) signal), and that the term GNSS may cover any higher-orbit satellite navigation or augmentation system (e.g., SBAS).

By providing navigation signals as described above, availability of the navigation service may be improved, along with received power on ground. Moreover, additional benefits may result from frequency diversity and or measurement diversity.

In some embodiments, a duty cycle of the TDD mode may be synchronized with timing epochs of the GNSS. The timing epochs of the GNSS may be derived (e.g., computed) from onboard ODTS using GNSS signals.

In some embodiments, the method may further include performing at least one of orbit determination or time synchronization for the satellite payload based on the GNSS signal(s). Orbit determination and time synchronization (ODTS) may use an on-board filter, e.g., Kalman filter, and/or a precise point positioning, PPP, algorithm. It may generally be based on content/information transmitted with the GNSS signal. The ODTS may also yield an estimate of the timing epochs of the GNSS.

In some embodiments, synchronization of the duty cycle of the TDD mode to the timing epochs of the GNSS may be performed based on a result of the at least one of orbit determination or time synchronization.

In some embodiments, the at least one of orbit determination or time synchronization may be based on a high accuracy correction received with the GNSS signal(s). Additionally or alternatively, the at least one of orbit determination or time synchronization may use information about the authenticity of the GNSS signal(s). Additionally or alternatively, the at least one of orbit determination or time synchronization may use information about the integrity of the GNSS signal(s).

In some embodiments, the at least one of orbit determination or time synchronization may be based on one or more of: a Space Based Augmentation Systems (SBAS) message received with the GNSS signal; ranging authentication and/or message authentication of the GNSS signal; a High Accuracy Service (HAS) message received with the GNSS signal; and/or an integrity support message (ISM) received with the GNSS signal.

In some embodiments, the method may further include maintaining signal tracking of the GNSS signal(s) during time slots for transmitting the navigation signal to avoid re-acquisition, based on a result of the at least one of orbit determination or time synchronization. In particular, the signal tracking may be maintained to avoid re-acquisition of the GNSS signal(s) tracking when transmission of the navigation signal by the payload stops and reception of the GNSS signal(s) by the payload resumes. Maintaining the signal tracking may include, for example, maintaining tracking algorithms within pull-in boundaries of the tracking loops or within boundaries of lock indicators, and/or extrapolating tracking parameters and states to prevent the tracking loops to leave the pull-in range or loose lock during time slots when reception of the GNSS signal(s) is interrupted and the navigation signal is transmitted.

In some embodiments, the method may further include demodulating the GNSS signal(s) to obtain GNSS content transmitted with the GNSS signal. The method may yet further include including at least part of the GNSS content into a navigation message transmitted with the navigation signal in the GNSS frequency band towards Earth. The GNSS content obtained in this manner may relate to a (low latency) GNSS message, for example.

In some embodiments, the GNSS content may relate to one or more of: a SBAS message; a synthetic aperture radar (SAR) return link message; an integrity support message (ISM); a high accuracy service (HAS) message; an emergency warning message; and/or an authentication message.

In some embodiments, the aforementioned GNSS frequency band may be a first GNSS frequency band and the method may further include transmitting a second navigation signal towards Earth in a second GNSS frequency band different from the first GNSS frequency band or in a non-GNSS frequency band, in frequency division duplex (FDD) mode. Transmission and/or reception on the second GNSS frequency band may be continuous.

In some embodiments, the method may further include performing radio occultation based on the received GNSS signal(s) in the time slots for receiving the GNSS signal(s) of the TDD mode.

In some embodiments, the method may further include performing reflectometry based on the received GNSS signal, reflected for instance on Earth surface, in the time slots for receiving the GNSS signal(s) of the TDD mode.

In some embodiments, the method may further include performing operations for detecting and/or locating unwanted emission in the GNSS frequency band. Locating unwanted emission may involve multilateration using multiple satellite payloads in some implementations.

In some embodiments, the method may further include performing radio interference estimation in the time slots for receiving the GNSS signal(s) of the TDD mode.

In some embodiments, the navigation signal may be a navigation signal for code-based ranging measurements, carrier-based ranging measurements, and/or Doppler measurements at a receiver and/or low complexity acquisition at a receiver. In some embodiments, the navigation signal may be a navigation signal for code-based ranging measurements, carrier-based ranging measurements, and/or Doppler measurements at a receiver.

In some embodiments, the method may further include receiving an uplink signal from user equipment for two-way navigation services. Two-way navigation services may relate to one or more of: a time transfer between the user equipment and the payload; a time transfer between the user equipment and another user equipment; bounding of the time of the user equipment; bounding of the position of the user equipment; and/or verification of the position of the user equipment by the payload.

In some embodiments, the payload may be a satellite payload aboard a satellite in Low Earth Orbit (LEO).

In some embodiments, several payloads may be provided aboard respective spacecraft in a layer of a multi-layer satellite navigation system. The multi-layer satellite navigation system may include one or more satellites in MEO, one or more satellites in LEO, and/or one or more satellites in GEO, for example. Thereby, the several payloads may be distributed for example across a layer of the multi-layer satellite navigation system comprising the one or more satellites in LEO. The spacecraft (e.g., satellites) in a given layer may be arranged in different orbital planes, at different inclinations, and/or at different altitudes.

In some embodiments, the composition of the uplink signal may depend on prior reception of a downlink navigation message by one or more of: a signal from the payload; a signal from another payload; and/or a GNSS signal.

In some embodiments, the GNSS frequency band may be one of the bands E1, E6, E5, E5a, and E5b as defined for Galileo or one of L1, L2 and L5 as defined for GPS.

Another aspect of the disclosure relates to a satellite payload with receive and transmit capabilities. The satellite payload may be configured to perform the method according to the foregoing aspect or any of its embodiments.

Another aspect of the disclosure relates to a satellite comprising the satellite payload according to the foregoing aspect.

Another aspect relates to a satellite navigation system comprising one or more payloads according to the aforementioned aspect.

It will be appreciated that apparatus features and method steps may be interchanged in many ways. In particular, the details of the disclosed apparatus or system (e.g., satellite payload, satellite, or satellite constellation) can be realized by the corresponding method of operating the apparatus/system or parts thereof, and vice versa, as the skilled person will appreciate. Moreover, any of the above statements made with respect to the apparatus/system are understood to likewise apply to the corresponding method, and vice versa.

### BRIEF DESCRIPTION OF THE SEVERAL VIEWS OF THE DRAWINGS

Example embodiments of the disclosure are explained below with reference to the accompanying drawings, wherein:

FIG. 1 schematically illustrates an example of a framework to which techniques according to the present disclosure may be applied;

FIG. 2 is a flowchart illustrating an example of a method of operating a payload according to embodiments of the disclosure;

FIG. 3 schematically illustrates an example of using a TDD mode in a terrestrial telecommunication system;

FIG. 4 schematically illustrates an example of using the TDD mode in a satellite navigation scenario according to embodiments of the disclosure;

FIG. 5A and FIG. 5B schematically illustrate examples of timing synchronization for TDD transmit time slots according to embodiments of the disclosure;

FIG. 6 is a flowchart illustrating an example of optional steps for the method of FIG. 2 according to embodiments of the disclosure;

FIG. 7 is a block diagram schematically illustrating a procedure for aiding tracking of a GNSS signal received in TDD mode by information derived from continuous reception of another GNSS signal according to embodiments of the disclosure;

FIG. 8 is a flowchart illustrating an example of further optional steps for the method of FIG. 2 according to embodiments of the disclosure;

FIG. 9 schematically illustrates an example of a scheme for relaying GNSS message content to navigation signals according to embodiments of the disclosure;

FIG. 10 is a flowchart illustrating an example of further optional steps for the method of FIG. 2 according to embodiments of the disclosure;

FIG. 11 schematically illustrates an example of a framework for performing radio occultation according to embodiments of the disclosure;

FIG. 12 schematically illustrates an example of a framework for performing radio frequency interference estimation according to embodiments of the disclosure; and

FIG. 13 schematically illustrates an example of a framework for integrating 2-way signaling functions according to embodiments of the disclosure.

### DETAILED DESCRIPTION

### Overview

The present disclosure relates to payloads (e.g., satellite payloads), to methods of operating such payloads (e.g., navigation or positioning methods), and to corresponding satellites. One example of such satellite is a LEO satellite for providing a Positioning, Navigation, and Timing (PNT) service, or LEO-PNT satellite for short. While the present disclosure may frequently make reference to LEO-PNT satellites and payloads, this is in no way to be interpreted as limiting. Rather, the present disclosure relates to suitable satellites and payloads other than LEO-PNT satellites and payloads, as the skilled person will appreciate, and makes reference to LEO-PNT as a non-limiting example, for reasons of conciseness. It is understood that other suitable satellites and payloads are also meant to be included when the present disclosure makes reference to LEO-PNT satellites, payloads, and methods of operating same.

Broadly speaking, LEO-PNT (as a non-limiting example of satellites, payloads, and methods according to the present disclosure) aims to augment and/or complement satellite navigation systems in Medium Earth Orbit (MEO; e.g., between 2,000 and 35,786 km above sea level), Inclined Geosynchronous Orbit (IGSO) and geostationary orbit (GEO), such as GNSS and SBAS, with additional signals transmitted from payloads deployed in LEO, whose transmissions are disciplined to GNSS time, and whose position at the time of transmission is referenced to GNSS reference frames.

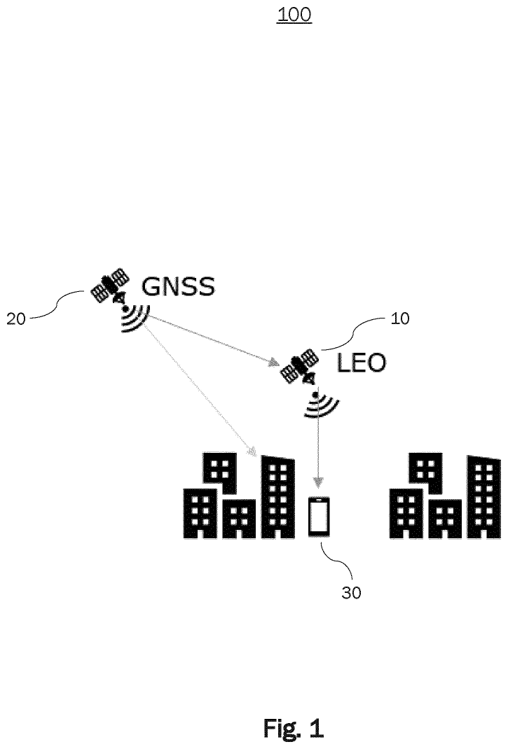

FIG. 1 schematically illustrates an example framework in which techniques according to embodiments of the disclosure may be employed. In this framework, a satellite (e.g., LEO satellite, LEO-PNT satellite) 10 receives higher orbit navigation or augmentation system signals (e.g., MEO GNSS signals, GEO augmentation signals, SBAS signals, etc.) from one or more higher orbit satellite navigation or augmentation system (e.g., GNSS, SBAS, etc.) satellite 20, for example in the L-band. Both satellites may transmit signals to user equipment on ground or in Earth's atmosphere. Signals from satellite 10 may be referred to as navigation signals (e.g., LEO-PNT signals) and signals from satellite 20 may be referred to as GNSS signals, without intended limitation.

LEO-PNT may augment and/or complement satellite navigation in various ways, depending on the targeted users and their needs. This includes the provision of signals allowing to derive positioning-velocity/timing related measurements by the user equipment (e.g., ranging, Doppler, and carrier phase measurements) and of signals delivering navigation-related data to the user equipment.

The LEO-PNT signals augment the experience of users of GNSS signals, for instance in terms of performances such as accuracy, availability, robustness and resilience, convergence time of high-accuracy PVT solutions (e.g., PPP algorithms) when GNSS signals are impaired for example due to challenging environments (e.g., obstruction, reflection of signals by buildings or natural obstacles, higher attenuations under canopy or inside buildings, higher noise floor, etc.). The LEO-PNT signals may also enable user equipment to derive positioning-navigation-timing information and solutions using only those signals, and/or in combination with GNSS signals, and/or in combination with other sources of information such as dead-reckoning, cellular communication systems, and any combinations thereof.

The contributions of the LEO-PNT signals to the improved performances may be enabled by features including:

Increased number of satellites available to the user equipment (compared to GNSS-only satellites) to combine them with other sources of PNT signals such as GNSS in MEO, systems in IGSO and GEO, transmitters from terrestrial cellular systems (e.g., 4G/5G, WIFI). This is useful in challenging environments to improve the number of available satellites for positioning-navigation-timing and the resulting geometry of the signals processed by the user equipment to derive a position-velocity-timing solution.

Provision of signals with increased received power to the user equipment. This improves acquisition and tracking performances of the signals (e.g., reduced acquisition time and energy consumption, improved statistics for carrier cycle slips and loss of lock, improved estimation and mitigation of multipath as the algorithms involved in the later perform better at higher signal to noise ratio of the line-of-sight signals, improved data demodulation and availability) and allows to improve coverage in environments affected by increased propagation losses (e.g., canopy, indoor). Measurement diversity. The faster motion of the payloads transmitting the LEO-PNT signals introduces different behavior of the errors of the measurements made on the signals by the user equipment when compared to signals from MEO. This signature difference, source of diversity, translates into different noise and statistics of the errors and multipath, faster decorrelation of the measurements, etc., which the user equipment algorithms can leverage to improve performances (accuracy, convergence time, availability when combined to dead-reckoning sensors, etc.). Frequency Diversity. The LEO-PNT signals can be transmitted on carriers in frequency bands like those of GNSS, and additionally or alternatively, on frequency bands different from GNSS frequency bands. The latter benefits the user experience and the performances accessible to the user equipment. Frequencies below the current GNSS frequencies (e.g., signals on carrier frequencies below 1 GHz) would feature better propagation, lower attenuation under canopy or inside building, and thus improved performance for use cases in these situations. Frequencies well above the current GNSS frequencies (e.g., above 5 GHz) will typically feature increased signal bandwidth (source of improved ranging accuracy and robustness) and will be less affected by propagation through the ionosphere, thus delivering improved accuracy and robustness. Examples include frequency bands in UHF, S-band, C-band, and Ku/K/Ka-band.

Frequency diversity is beneficial for LEO-PNT signals and targeted capabilities. Nonetheless, the transmission of LEO-PNT signals in the same bands as the GNSS signals is also beneficial. Indeed, it allows the reception of the LEO-PNT signals with the same RF front-end at the user equipment, and potentially similar baseband processor, as the one used for GNSS signals, which significantly simplifies the user equipment and therefore the adoption of LEO-PNT signals.

Furthermore, in addition to frequency diversity, transmission on multiple frequencies is also helpful to enable mitigation of ionospheric effects (e.g., dual or multiple frequency combinations) and support higher accuracy for the users' Position, Velocity, and Time (PVT). It can therefore be desirable for LEO-PNT signals to be transmitted in 2, possibly 3, frequency bands common with GNSS (e.g., E1, E6 and E5 for Galileo, or L1, L2 and L5 for GPS or a combination of 2 or 3 out of these, etc.).

The dissemination of data with content relevant to PNT applications and supporting the user algorithms and/or the user experience by means of LEO-PNT signals may also be advantageous. Indeed, the LEO-PNT signals experience lower free space losses, which may yield high SNR, and as a result can enable higher throughput and/or higher availability compared to signals from MEO. In addition, the time lapse during which a signal from LEO is obstructed for a user on Earth, for instance by a building or natural obstacles, is shorter compared to MEO signals. This contributes to reducing the latency or time required to correctly demodulate all required information.

Examples of such data relevant to PNT applications include (but are not limited to) data relating to the orbit and clock data of the navigation signals (e.g., GNSS, LEO, etc.), corrections to these (e.g., PPP corrections), information necessary to estimate the reliability of integrity of the signals (e.g., SBAS, Integrity Support Message for ARAIM concepts), information necessary to authenticate the source of the data and/or of the signals (e.g., OSNMA from Galileo), other information relevant for the applications derived from the PVT solutions of the user equipment such as information relating to emergency warning (e.g., EWS messages). These data can be uploaded to the LEO-PNT payload by means of ground-to-space links, satellite communication links, and advantageously received directly on board via signals incoming from higher orbit navigation or augmentation system signals, such as MEO GNSS signals or augmentation signals from GEO (e.g., SBAS).

LEO-PNT signals can also complement GNSS, satellite navigation, and terrestrial navigation systems in areas described hereafter, with features leveraging the nature of the signals or of the proximity of the payload to the Earth, being in LEO, or a combination of both.

LEO-PNT signals and systems may contribute to support positioning with very low energy per fix, which is beneficial to increase the battery lifetime of asset tracking devices.

Additional capabilities may include support for two-way PNT links, with the processing by the LEO-PNT payload of signals uplinked by the user equipment. LEO-PNT satellites are closer to Earth, which can facilitate the provision of new two-way services thanks to the lower Equivalent Isotropic Radiated Power (EIRP) required for the user terminals on ground. Some possible two-way services include two-way time and frequency satellite transfer using LEO satellites, detection and location of emergency calls, and verification of user location, where the uplink signals from the user, or two-way signals, are exploited to verify the position of the user either by processing on board the LEO-PNT satellites or the ground segment. In some cases, it may be relevant to consider placing the carrier frequency of the uplink in a band in close vicinity of (e.g., adjacent to) GNSS bands, to reduce complexity of the user terminal and of the LEO-PNT payload antenna.

LEO-PNT systems can also accommodate ancillary capabilities relating to GNSS signals received from LEO such as: GNSS Radio-Occultations (RO), GNSS reflectometry, as well as monitoring the radio frequency spectrum to detect and locate RF interference that may be generated, for instance, on Earth in GNSS frequency bands.

LEO-PNT satellites can carry GNSS radio occultation (GNSS-RO) instruments to collect measurements from GNSS satellites at low elevations and downlink them to ground (e.g., via Telemetry, Tracking, and Control (TTC) and possibly one or more Inter-Satellite Link (ISL) hops). Alternatively or additionally, estimation processes can be run on board the LEO-PNT payloads and the results thereof can be sent to users via the LEO-PNT signals. The principle of radio-occultation can be expanded beyond GNSS signals to also incorporate other signals received by a LEO-PNT payload and occulted by the atmosphere, in particular LEO-PNT signals received from other LEO-PNT satellites, or signals from ISLs between LEO-PNT satellites. The information derived from the radio-occultation measurements (e.g., GNSS-RO, ISL-RO or LEO-PNT-RO) can be provided and exploited by other systems or infrastructures involved in the provision of satellite navigation services (e.g., SBAS, GNSS systems, GNSS augmentation systems on ground, etc.) together with additional data (e.g., from their respective ground segments) to derive corrections for the atmospheric effects on GNSS signal propagation (e.g., SBAS ionosphere correction messages, GNSS broadcast ionosphere correction messages, GNSS precise ionosphere products in support of PPP algorithms, etc.).

LEO-PNT satellites may also carry GNSS Reflectometry (GNSS-R) instruments to collect measurements from GNSS signals reflected from the surface of Earth and downlink them to ground (e.g., via TTC and possibly one or more ISL hops), so that this information can be used for Earth observation purposes (e.g., measuring wave height and wind speed) or for geolocating vessels or assets on Earth.

GNSS receivers on-board LEO-PNT satellites can be used to collect measurements from GNSS satellites and downlink them to ground (e.g., via TTC and possibly one or more ISL hops), so that this information can be used to improve capabilities and performances of GNSS systems and services implemented by the user equipment. This includes improved clocks and ephemeris information of GNSS systems, monitoring of the quality of the GNSS signals, and detection of impairments and integrity issues on signals from GNSS. Data collected by GNSS receivers on-board LEO-PNT satellites can be processed on board to detect GNSS integrity issues (e.g., using RAIM-like algorithms) and inform the user in real-time through the LEO-PNT signals.

The time of transmission of LEO-PNT signals, as well as the position of the transmission sources (e.g., satellite, phase center of the LEO-PNT payload antennas, etc.) need to be determined and communicated to the user equipment to enable computation of the position by the user equipment (e.g., via trilateration). Orbit Determination and Clock Synchronization (ODTS) referenced to GNSS frames may be highly relevant to optimize the use of the LEO-PNT signals in combination with GNSS signals and facilitate adoption by manufacturers and users already acquainted with GNSS based technologies.

Many applications of LEO-PNT signals and systems may require high-accuracy positioning, therefore low User Equivalent Range Error, to which ODTS may contribute. Furthermore, for many applications, the LEO-PNT signals and their sources may need to be trustworthy. Trustworthiness in the present context is understood to contemplate the notion of integrity known to GNSS communities (e.g., as awareness of the measurement statistics and the probability that the error exceeds a certain alert limit) as well as the notion of authenticity of the information carried by the LEO-PNT signals (e.g., the authenticity of origin of the signals and awareness of risk of tampering of the signals or their content).

In view of some or all of the above considerations, the drivers for the LEO-PNT payloads may include one or more of the following:
Transmission of at least one LEO-PNT signal in a band common to GNSS signals (and possibly 2, or even 3), and optionally (e.g., preferably) at least one LEO-PNT signals in a band different from those of GNSS signals
Computation of high-accuracy ODTS and information and indicators about its trustworthiness
Access to navigation messages from GNSS and SBAS signals to relay some of their content to the users,
Reception of signals in GNSS bands to support ancillary capabilities such as GNSS Radio-Occultation, GNSS reflectometry, RFI monitoring, collection of GNSS measurements for improving GNSS-related products (e.g., GNSS ODTS, integrity, etc.) and/or receive signals in GNSS bands or in bands in close vicinity of GNSS bands to support processing of uplink incoming from the user equipment
Transmission of the LEO-PNT signals referenced to GNSS time and position frames, derived from High-accuracy ODTS of the LEO-PNT payloads and signals, and association of the ODTS with information and indicators about the trustworthiness of the ODTS for the user, including integrity and authentication
Reception of an uplink signal from the users for providing two-way navigation services

### Key Features and Implementation Options

A typical architecture of a LEO-PNT system involves a LEO-PNT payload, on one or more satellites in LEO, and optionally an ensemble of functions and capabilities on ground (e.g., ground control and mission segment) for monitoring, control, and operations of the LEO-PNT missions, and the user segment including the user equipment.

The LEO-PNT space segment can comprise or consists of a set of Earth-orbiting satellites in multiple orbital planes, which can be in a single or multiple inclinations and in a single or multiple altitudes. The LEO-PNT space segment could be implemented as a dedicated constellation or as a hosted payload on other satellites or in a hybrid approach combining payloads dedicated satellites and payloads hosted on other satellites. The LEO-PNT constellation is composed by multiple satellites distributed in multiple orbital planes which can be in one or more inclinations and one or more altitudes, for instance to optimize coverage in specific areas (e.g., urban canyons of populated areas of the world, polar latitudes, etc.) and can allow for different distribution of the capabilities on these planes.

The payload may also involve supporting functions such as interfaces with TTC functions and equipment. LEO-PNT satellites may include ISL transceivers and antennas to exchange data with other LEO-PNT satellites within the field of view and/or to derive Inter-Satellite Ranging (ISR) measurements. The ISL can be based on Radio Frequency (RF) and/or optical technologies and can operate among satellites on the same plane (intra-plane) or on different planes (inter-plane), or a combination of both. The use of TTC links for managing mission data and information and parameters for the LEO-PNT payloads may have the advantage of simplicity, however at the cost of increased latency compared to ISL.

Considering the drivers listed in the Overview section, the core functions of the LEO-PNT system and payload may include the following functions:
Computation of accurate and trustworthy ODTS
Making available the content of the navigation message to the LEO-PNT payload for relaying on the LEO-PNT signals
Generation of LEO-PNT signals necessary to enable the services and capabilities of the LEO-PNT system (e.g., ranging, data dissemination, etc.) in various bands including GNSS bands, disciplined to the aforementioned ODTS
Reception and processing of signals uplinked by the user equipment in case of integration of 2-way functions in the LEO-PNT system and payloads
Functions to support ancillary capabilities such as GNSS Radio-Occultation, GNSS reflectometry, and RFI monitoring

This may imply one or more of the following features for the LEO-PNT payloads:
Simultaneous transmission and reception of signals in GNSS bands
Computation of high-accuracy ODTS
Computation of information and indicators about the trustworthiness of the ODTS
Generation of LEO-PNT signals in various bands including GNSS, disciplined to this ODTS, to enable the user equipment to derive the relevant PVT related measurements, and which LEO-PNT signals contain data relating to ODTS, its trustworthiness, as well as additional data, some of them originating from external sources
Reception of an uplink signal from the users for providing two-way navigation services

ODTS of LEO satellites can be estimated with various methods and concepts, as the skilled person will appreciate. One method involves a network of sensor stations on ground, deriving range and/or range rate and/or carrier phase measurements from signals incoming from the LEO satellites and LEO-PNT payloads, similarly to the concept operated in GNSS ground segments. Differential corrections can also be applied to ODTS derived from TTC stations, but would be valid only for users in vicinity of the differential stations (e.g., similarly to Differential GNSS (DGNSS) and Real Time Kinematic (RTK) concepts for GNSS). These methods may involve or require additional hardware on board and on ground (e.g., high performance and potentially complex clock system to maintain stability over long duration, low latency links to ground, and network of sensor stations). ODTS can also be derived from the processing of measurements from links among the LEO-PNT satellites (e.g., ISLs).

Given that the LEO-PNT satellites are in orbits below the GNSS and therefore receive the signals of the latter in good conditions, an advantageous solution may be to discipline the LEO-PNT signals' transmission and reference position to an accurate and trustworthy ODTS performed onboard in real-time, using measurements from the reception of GNSS signals by an on-board receiver. Furthermore, this receiver can be integrated into the LEO-PNT payload to optimize performances (e.g., time synchronization of the processing), as well as to reduce interfaces, size, weight, etc. The ODTS can use, for example, a real-time Precise On-board Orbit Determination (P2OD) algorithm using both pseudo-range and carrier phase measurements with floating ambiguities or with Integer Ambiguity Resolution (IAR) capabilities.

The ODTS process can use data and/or corrections (e.g., orbits data, clock corrections, inter-signal, biases, inter-frequency biases, ionospheric corrections, code biases, phase biases, etc.) to improve its accuracy from a few tens of centimeters to better than ten centimeters. For this, specific information may need to be considered and made available to the onboard ODTS functions, which are not integrated in the so-called clock and ephemeris data or standard navigation message of the GNSS signals (e.g., LNAV, CNAV, CNAV-2 from GPS, I/NAV and F/NAV from Galileo).

The integrity of the ODTS solutions can be derived for example implementing Receiver Autonomous Integrity Monitoring (RAIM) or Advanced RAIM (ARAIM) concepts, or using integrity information generated by SBAS augmentation systems, or a combination of these. The authenticity of the navigation message containing the clock and ephemeris data of the GNSS signals may also need to be accessible to the LEO-PNT payload to compute authentic ODTS information.

The data necessary to deliver an accurate and trustworthiness information from GNSS signals may not be contained in the navigation message of those signals (e.g., GPS messages on L1 C/A, L2C, L5 and LlC, I/NAV and F/NAV for Galileo). The corrections to improve accuracy and integrity and to confirm the authenticity of the navigation message used in the ODTS can be made available onboard with side links, or non-GNSS links, as it is the case for terrestrial users (e.g., PPP corrections received over internet links, Assisted GNSS protocols from terrestrial cellular networks, so-called L-band corrections services delivered via satellite communications systems), or via uplink telecommands or via ISLs, which would connect to ground to source this information. In all cases, this may involve additional equipment onboard, as well as additional dependency of the onboard ODTS to external technologies, sources of information or service providers.

While the aforementioned links may have some advantages, they also may come with significant drawbacks including additional complexity and dependencies for the LEO-PNT system(s). The LEO-PNT payload can make advantageous use of additional information contained in specific GNSS and SBAS signals, to access the information required to derive the trustworthiness of the ODTS. This includes the reception of SBAS signals, reception of the Galileo HAS corrections broadcasted on the E6B signals, as well as reception of authentication features carried by GNSS signals such as Navigation Message Authentication and encrypted signals (e.g., OSNMA and CAS of Galileo, Chimera of GPS). A key advantage for the LEO-PNT payload may lie in its simplicity, as the reception of these signals and information can be integrated into the GNSS onboard receiver.

Similarly, specific information to relay to the users via LEO-PNT signals can be received directly from specific signals and messages from systems such as GNSS (e.g., Galileo, GPS) and SBAS.

Many benefits and added-value functions may result from the measurements and data derived from the reception of specific GNSS signals by the LEO-PNT payloads. This mandates the reception of well-determined GNSS signals and data available in specific frequency bands by the onboard GNSS receiver, for example E1/L1 (SBAS, Galileo OSNMA), E6 (Galileo HAS, CAS), E5 (for dual frequency measurement common between Galileo and GPS, SBAS DFMC), reception of dual frequency signals for radio-occultation, reception of several GNSS bands for signal quality monitoring and interference detection, while transmitting the LEO-PNT signals, some of them in the GNSS bands as well.

To generate the relevant LEO-PNT signals in GNSS bands while receiving information and deriving measurements from GNSS and SBAS signals, the accommodation of the reception and transmission of signals operating in GNSS bands, may therefore be instrumental to the foreseen LEO-PNT concepts. Furthermore, the functions enabling the key features of LEO-PNT payloads (e.g., high accuracy ODTS, ancillary functions using GNSS bands, etc.), may be impacted by this accommodation, and therefore also need to be tailored to this accommodation in order to deliver the optimal performances.

### Example Payload Implementation

The core functions of the LEO-PNT payload may comprise:
Functions to receive and process signals incoming from MEO satellites (e.g., GNSS), GEO satellites (e.g., SBAS), for example in L-band, and possibly from satellites on other orbits above the LEO such as IGSO systems, or higher-orbit satellite navigation or augmentation signals in general, from higher-orbit satellite navigation or augmentation systems
Functions to compute accurate and trustworthy ODTS
Functions to generate, in various bands including GNSS, the LEO-PNT signals necessary to enable the services and capabilities of the LEO-PNT system (e.g., ranging, data dissemination, etc.) and to discipline them to the aforementioned accurate and trustworthy ODTS
Function to receive signals uplinked by the user equipment in case of integration of 2-way functions in the LEO-PNT system and payloads
Functions to support ancillary capabilities such as GNSS-RO, GNSS reflectometry and RFI monitoring

The payload will thus have to receive and transmit signals operating in GNSS bands (GNSS frequency bands). A feasible method to implement these functions while avoiding the crosstalk between the transmission and reception in GNSS bands may be instrumental to the payloads design and operations.

The above refers to higher-orbit satellite navigation or augmentation signals that are received and processed by payloads according to embodiments of the present disclosure. These signals relate to navigation signals received from a satellite navigation or augmentation system (e.g., GNSS, SBAS) in a higher orbit (e.g., an orbit above LEO). Further, these signals may be received from the higher orbit satellite navigation or augmentation system in the L-band. They may generally be said to be received in frequency bands used by GNSSs or augmentation systems (e.g., SBAS). While the present disclosure frequently makes reference to GNSS signals, it is understood that it likewise relates to higher-orbit satellite navigation or augmentation signals, including, but not limited to, GNSS signals and/or SBAS signals.

### Simultaneous Transmission and Reception of Signals in GNSS Bands

GNSSs (as a non-limiting example of higher-orbit satellite navigation or augmentation systems) represent most satellite navigation systems and may therefore be seen as typical and representative of current satellite navigation systems. The GNSS signals (as a non-limiting example of higher-orbit satellite navigation or augmentation signals) are transmitted continuously, so that the signal, the associated payloads, and receiving functions are designed accordingly for continuous operations.

The LEO-PNT payload (as a non-limiting example of a payload or satellite payload) described in the present disclosure is capable of transmitting and receiving signals in the GNSS bands. The transmission of a signal from the LEO-PNT payload may affect the operation of the nearby reception function on the same payload. The transmission may at least significantly increase the noise floor in the reception band, potentially preventing the correct processing of the signals intended to be received to support the LEO-PNT payload, likely saturate the hardware functions in the receiver (e.g., saturation of the LNA, operation well beyond the linear region of most receiving functions involved, etc.), and potentially deteriorate them.

A feasible solution to support the operation of transmission and reception in GNSS bands would be to allocate the transmission and the reception to different frequency bands, which will be referred to as Frequency Division Duplexing (FDD) mode in the context of the present disclosure. Compatibility between LEO-PNT signal transmission (e.g., in L band) and reception of GNSS signals by the on-board GNSS receiver when operating in FDD mode can be ensured by one or more of:
Out-of-band emission filter at the LEO-PNT signal transmitter
Out-of-band rejection filter at the GNSS receiver
Digital Signal Processing (DSP) at GNSS receiver level for interference cancellation (e.g., Self-Interference Cancellation (SIC) techniques), knowing the exact nature and content of the transmitted signal.

The transmitting and receiving antennas may be designed to minimize their coupling and thus minimize crosstalk between transmitter and receiver. Additionally or alternatively, transmitting and receiving antennas can be installed as far as possible spaced away from each other if the size and accommodation of the satellite allows. All these techniques may require additional hardware and/or additional footprint (e.g., for accommodating filters), and may introduce specific accommodation constrains which are typically not desirable. Furthermore, they constrain the design of the LEO-PNT payload's frequency plan in GNSS bands, limiting the choice for those bands operating in reception and those bands operating in transmission, which may not be desirable to achieve optimal performances and facilitate implementation for the user equipment.

Contrary to the above, the present disclosure proposes to introduce (and optimally configure) alternating transmission and reception functions on a same GNSS frequency band in the LEO-PNT payload, one alternating with the other according to a certain period and duty-cycling. This technique, which will be described in more detail below, will be referred to as Time Division Duplexing (TDD) throughout the disclosure.

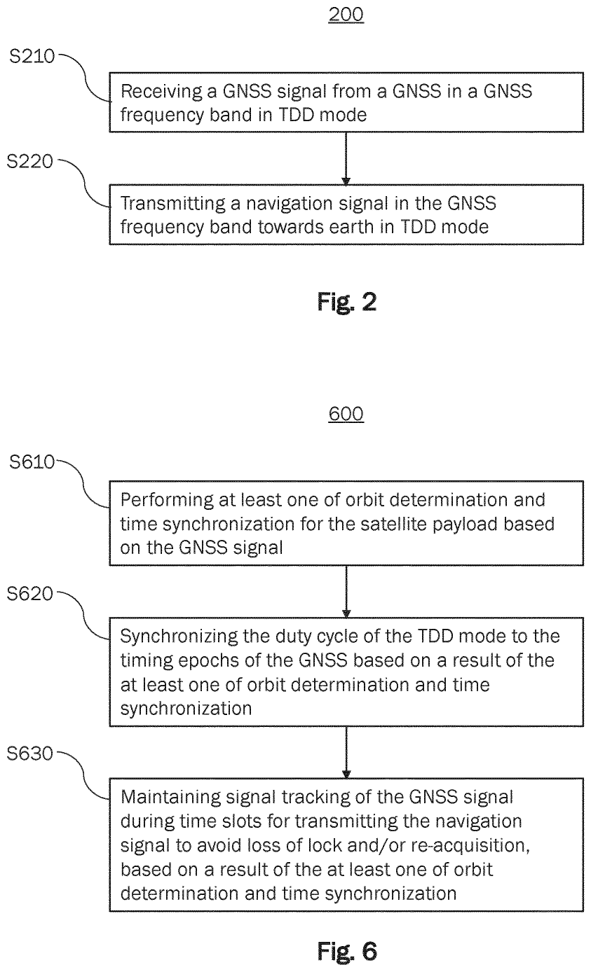

An example of a method 200 of operating a payload (e.g., satellite payload, LEO-PNT payload) with receive and transmit capabilities is now described with reference to the flowchart of FIG. 2. This method 200 may be performed for example in Earth orbit, such as LEO, for example. Further, the method 200 may be said to correspond to a positioning or navigation method. While additional steps not shown in FIG. 2 will be described below, the method 200 may at least comprise steps S210 and S220. Notably, these steps, or a sequence thereof, may be performed continuously.

At step S210, a GNSS signal is received from a GNSS in a GNSS frequency band.

While reference is made here to a GNSS signal, it is understood that this step generally relates to reception of higher-orbit satellite navigation or augmentation signals. These signals relate to navigation signals received from a satellite navigation or augmentation system (e.g., GNSS, SBAS) in a higher orbit (e.g., an orbit above LEO). Thus, it is understood that any techniques presented herein likewise relate to higher-orbit satellite navigation or augmentation signals, including, but not limited to, GNSS signals and/or SBAS signals.

The aforementioned GNSS signal (as a non-limiting example of a higher-orbit satellite navigation or augmentation signal) may be received from the higher orbit satellite navigation or augmentation system in a frequency band used by GNSSs or augmentation systems, which will be referred to as a GNSS frequency band. For example, the GNSS signal may be received in the L-band. More specifically, in some implementations, the GNSS frequency band may be one of bands E1, E6, E5, E5a, and E5b as defined for Galileo or one of L1, L2 and L5 as defined for GPS, for example.

At step S220, a navigation signal is transmitted in the GNSS frequency band towards Earth. Importantly, the navigation signal is transmitted in the same frequency band (e.g., at the same carrier frequency) in which the GNSS signal is received at step S210. Notably, this is understood to encompass cases in which the transmission frequency band is in a vicinity to the reception GNSS frequency band, sufficiently close so that the spectrum of the transmitted and received signals overlap in the frequency domain. In some implementations, the navigation signal may be transmitted in a frequency band overlapping with the GNSS frequency band.

The navigation signal transmitted at step S220 may be a navigation signal for code-based ranging measurements, carrier-based measurements, and/or Doppler measurements at a receiver (e.g., user equipment) and/or low complexity acquisition at the receiver. In this sense, the navigation signal may provide the same functionality as a GNSS signal.

Further, the navigation signal may be based, at least in part, on the GNSS signal. For example, the navigation signal (or content thereof) may be derived at least in part based on the GNSS signal (or content thereof). For example, the navigation signal may be based, at least in part, on a result of ODTS at the payload. Further, the navigation signal may include GNSS content derived from the GNSS signal and relayed via the transmitted navigation signal. Further details thereof will be described below.

In the above, the receiving at step S210 and transmitting at step S220 are performed in a TDD mode, with alternating time slots for receiving the GNSS signal and transmitting the navigation signal. That is, for a given TDD time slot, only one of a receiving functionality or transmitting functionality is active in the same frequency band, while in the subsequent TDD time slot, only the other one of the receiving functionality or transmitting functionality is active in the same frequency band.

Additionally, although not shown in FIG. 2, the method 200 may comprise an optional step (that may also be performed continuously) of transmitting a second navigation signal towards Earth in a second GNSS frequency band different from GNSS frequency band or in a non-GNSS frequency band. Transmission of the second navigation signal may be performed in FDD mode, in the sense that the second navigation signal is continuously transmitted, but in a frequency band distinct from the receive frequency band (i.e., the GNSS frequency band).

In general, receiving at step S210 and/or transmitting at step S220 may be performed in two or more (distinct) GNSS frequency bands. Additional transmission at step S220 may optionally be performed in a non-GNSS frequency band. It is understood that the TDD mode is applied to any (GNSS) frequency band that is used by the payload for both reception and transmission in the same frequency band.

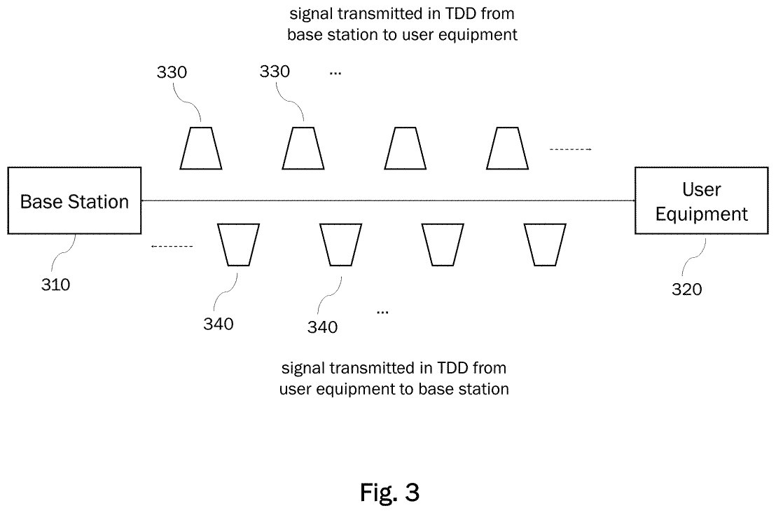

Conventionally, TDD is applied in terrestrial cellular networks, between the base station and the user equipment. An example of using TDD in communication between a base station 310 and user equipment (UE) 320 is schematically shown in FIG. 3. Here, continuous time is (virtually) divided into a sequence of consecutive time slots 330, 340, of which a subset of time slots 330 is used for transmission by the base station 310 (and reception by the UE 320), and the complementary subset of time slots 340 is used for transmission by the UE 320 (and reception by the base station 310). In this configuration, time slots 330 in which the base station 310 transmits (or may transmit) alternate with time slots 340 in which the UE 320 transmits (or may transmit).

Conventionally, TDD is typically not used in satellite telecommunications systems for various reasons, which makes the practical implementation TDD not attractive compared to FDD. Furthermore, as shown in FIG. 3, TDD is typically implemented in telecommunications systems between two nodes exchanging over a 2-way communication link (e.g., base station and user equipment).

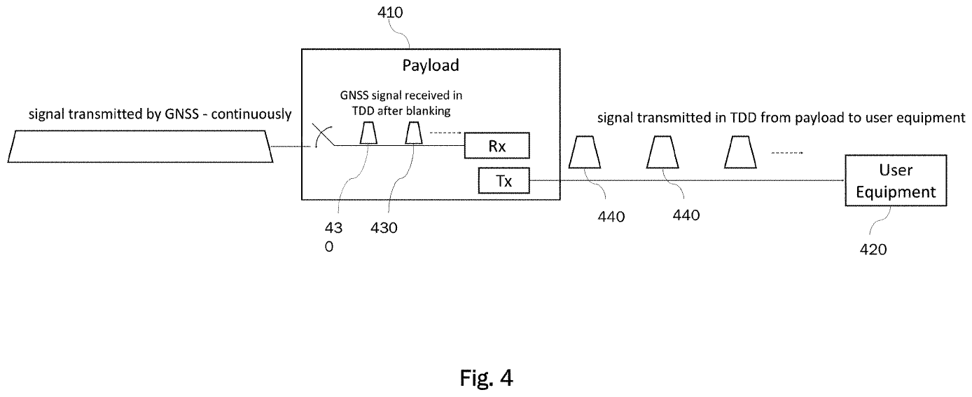

Contrary to that, the present disclosure proposes to use TDD for reception and transmission by a given payload, noting that TDD can be tailored to satellite payloads (e.g., LEO-PNT) as an attractive alternative to FDD for accommodating Rx/Tx in the same frequency band. An example of using TDD in Rx/Tx of a payload 410 that may transmit towards a UE 420 is schematically shown in FIG. 4. Again, continuous time is (virtually) divided into a sequence of consecutive time slots 430, 440, of which a subset of time slots 430 is used for reception by the payload 410, and the complementary subset of time slots 440 is used for transmission by the payload 410 towards the UE 420. In this configuration, time slots 430 in which the payload 410 receives (e.g., the GNSS signal) alternate with time slots 440 in which the payload 410 transmits (e.g., the navigation signal).

Tailoring the TDD mode to payloads according to the present disclosure may include application of TDD to the reception of signals broadcasted or transmitted by a certain set of transmitters (e.g., GNSS, SBAS, sources of interferences) and to the transmission of LEO-PNT signals to user receivers (i.e., the users of LEO-PNT signals). This is different from the use of TDD in terrestrial telecommunication systems where the transmitters and receivers are part of the same 2-way link.

In the example of TDD on GNSS bands, the LEO-PNT payload receives signals in GNSS bands while the transmission of LEO-PNT signals on GNSS bands is switched off, and vice-versa, as described above. Further, the LEO-PNT payload transmits LEO-PNT signals on GNSS bands while the reception is switched off on GNSS bands. Furthermore, the tailoring of TDD on the reception side would apply to signals that are transmitted continuously and therefore not duty-cycled before reaching the LEO-PNT payload front-end (nor designed for duty-cycled processing, unlike telecommunications signals that may be designed considering TDD implementations).

The transmission of TDD signals in the LEO-PNT payload, for example at step S220, may be implemented for example by switching off the signal at the input of the analog chain, blanking for instance the digital-to-analog converter and setting the signal to zero. An alternative may be to blank the signal at the input of the amplifier or chain of amplifiers, or to switch off the amplifier, or a combination of these measures.

The reception of signals in TDD signals in the LEO-PNT payload, for example at step S210, may be implemented for example by switching off the signal at the output of the analog front-end of the receiver, blanking for instance the analog-to-digital converter and setting the signal to zero. An alternative may be to blank the signal at the input of the analog front-end (e.g., Low Noise Amplifier (LNA)) or somewhere in the analog front-end.

An example period for the TDD pattern may range from one ms to a few tens of ms. Shorter pattern periods would facilitate implementation and performances at receiver level but could result in more complex implementation of the transmission chain. Longer pattern periods could facilitate the implementation but would put additional stress on the receiver algorithms and require additional complexity to maintain good performances.

An example duty-cycling of the TDD may be at 50%. Lower percentages for the transmission side would allow more time to receive signals in the LEO-PNT payload and therefore higher SNR on the reception side in the LEO-PNT payload but would provide less average power and SNR to the user of LEO-PNT signals. Conversely, higher percentages for the transmission would increase the average power and SNR delivered to the users but would reduce the SNR available to the receiver of the LEO-PNT payload.

An example of TDD reception and transmission in the E5 GNSS frequency band is illustrated in Table 1.

TABLE 1
TDD for one GNSS frequency band

| | | One GNSS band - e.g. E5/L5 | | | | |
|---|---|---|---|---|---|---|
| | | Tx | Rx | Tx | Rx | . . . |
| E5 in TDD | Tx | On | Off | On | Off | . . . |
| | Rx | Off | On | Off | On | . . . |

The implementation of TDD mode in the LEO-PNT payload is not necessarily exclusive of the FDD mode. For example, the two modes could be advantageously combined when transmission and reception is implemented on multiple bands simultaneously. An example thereof is illustrated in Table 2, where TDD reception and transmission is performed in the E5 GNSS frequency band, and the payload further continuously receives a GNSS signal in the E6 GNSS frequency band.

TABLE 2
TDD and FDD for respective GNSS frequency bands

| | | One band in TDD (e.g., E5/L5) | | | | |
|---|---|---|---|---|---|---|
| | | Tx | Rx | Tx | Rx | . . . |
| | | One band in FDD (e.g, E6) | | | | |
| | | Rx | Rx | Rx | Rx | . . . |
| E5 in TDD | Tx | On | Off | On | Off | . . . |
| | Rx | Off | On | Off | On | . . . |
| E6 Rx only | Rx | On | On | On | On | . . . |

Another example is illustrated in Table 3, where TDD reception and transmission is performed in the E5 GNSS frequency band, and the payload further continuously transmit a signal in the S-band.

TABLE 3
FDD continuous transmission and TDD Reception/Transmission

| | | One band in TDD (e.g., E5/L5) | | | | |
|---|---|---|---|---|---|---|
| | | Tx | Rx | Tx | Rx | . . . |
| | | One band in FDD Tx (e.g, S-band) | | | | |
| | | Tx | Tx | Tx | Tx | . . . |
| E5 in TDD | Tx | On | Off | On | Off | . . . |
| | Rx | Off | On | Off | On | . . . |
| S-band Tx only | Tx | On | On | On | On | . . . |

When transmission is operated on multiple bands, transmission (respectively reception) on the multiple bands can be implemented simultaneously or alternatively. Alternating transmission on several bands, and as a consequence, alternating reception on several bands, may be advantageous to optimize operation of the transmission chain. For instance, not all amplifiers would drain current at the same time, and the receiver would always process one signal at any time, which facilitates the processing of the signals and optimizes the resulting performance (e.g., helps maintain tracking loops locked, maintain continuity of the carrier phase, etc.). Examples thereof are shown in Table 4, Table 5, and Table 6.

TABLE 4
Optimized TDD RX and/or TX in several frequency bands

| | | Continuous Tx in S-band (FDD mode) | | | | |
|---|---|---|---|---|---|---|
| | | Tx | Tx | Tx | Tx | . . . |
| | | E1 in TDD | | | | |
| | | Tx | Rx | Tx | Rx | . . . |
| | | Continuous Rx in E6 (FDD mode) | | | | |
| | | Rx | Rx | Rx | Rx | . . . |
| E5 in TDD | | Tx | Rx | Tx | Rx | . . . |
| S-band Tx only Tx | | On | On | On | On | . . . |
| E1 in TDD | Tx | On | Off | On | Off | . . . |
| | Rx | Off | On | Off | On | . . . |
| E6 Rx only | Rx | On | On | On | On | . . . |
| E5 in TDD | Tx | Off | On | Off | On | . . . |
| | Rx | On | Off | On | Off | . . . |

TABLE 5
Optimized TDD Rx and Tx in several frequency bands
Maximum one Tx at the same time, At least 2 Rx at the same
time (continuity of dual frequency in LEO-PNT payload)

| | | E1 in TDD | | | | |
|---|---|---|---|---|---|---|
| | | Tx | Rx | Rx | Tx | . . . |
| | | E6 in TDD | | | | |
| | | Rx | Tx | Rx | Rx | . . . |
| E5 in TDD | | Rx | Rx | Tx | Rx | . . . |
| E1 in TDD | Tx | On | Off | Off | On | . . . |
| | Rx | Off | On | On | Off | . . . |
| E6 in TDD | Tx | Off | On | Off | Off | . . . |
| | Rx | On | Off | On | On | . . . |
| E5 in TDD | Tx | Off | Off | On | Off | . . . |
| | Rx | On | On | Off | On | . . . |

Table 5 includes Optimized TDD Rx and Tx in several frequency bands (1 Tx and 2 Rx at the same time).

TABLE 6
Optimized TDD Rx and Tx in several frequency bands
At least 2 Tx at the same time (continuity of dual
frequency at LEO-PNT user equipment)

| | | E1 in TDD | | | | |
|---|---|---|---|---|---|---|
| | | Tx | Rx | Tx | Tx | . . . |
| | | E6 in TDD | | | | |
| | | Tx | Tx | Rx | Tx | . . . |
| E5 in TDD | | Rx | Tx | Tx | Rx | . . . |
| E1 in TDD | Tx | On | Off | On | Or | . . . |
| | Rx | Off | On | Off | Off | . . . |
| E6 in TDD | Tx | On | On | Off | On | . . . |
| | Rx | Off | Off | On | Off | . . . |
| E5 in TDD | Tx | Off | On | On | Off | . . . |
| | Rx | On | Off | Off | On | . . . |

Table 6 includes Optimized TDD Rx and Tx in several frequency bands (2 Tx at the same time and 1 Rx)

Additional tailoring of the TDD mode to payloads according to the present disclosure include the synchronization of the TDD pattern (e.g., duty-cycling, period) to the GNSS time derived from the on-board ODTS and/or the optimization of the reception algorithms to recover the quality of the received signals despite the discontinuous reception. This may also involve leveraging parameters of the TDD (e.g., synchronization to GNSS time) and a combination of information on the transmitter geometry (e.g., ephemeris of the GNSS satellite) and of the LEO-PNT payload (e.g., onboard ODTS).

Accordingly, the method 200 described above may further include one or more of the steps of a method 600, which will now be described with reference to the flowchart of FIG. 6. Method 600 comprises steps S610, S620, and S630, each of which may be optional steps for the method 200 described above. Also these steps may be performed continuously.

At step S610, at least one of orbit determination or time synchronization for the satellite payload is performed based on the GNSS signal.

Details of ODTS will be described below.

At step S620, the TDD pattern (e.g., the duty cycle of the TDD mode and/or the period length of the TDD mode) is disciplined (e.g., synchronized) to the timing epochs of the GNSS. In some implementations, this may be based on a result of the at least one of orbit determination or time synchronization at step S610.

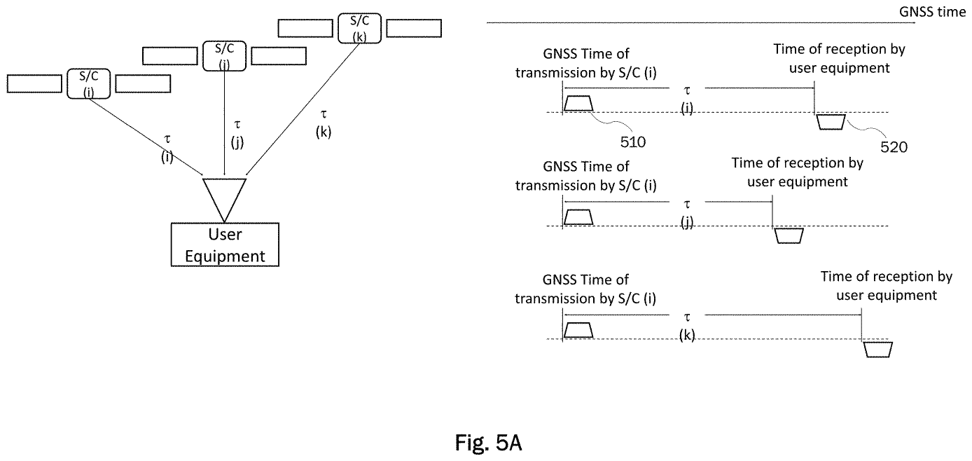

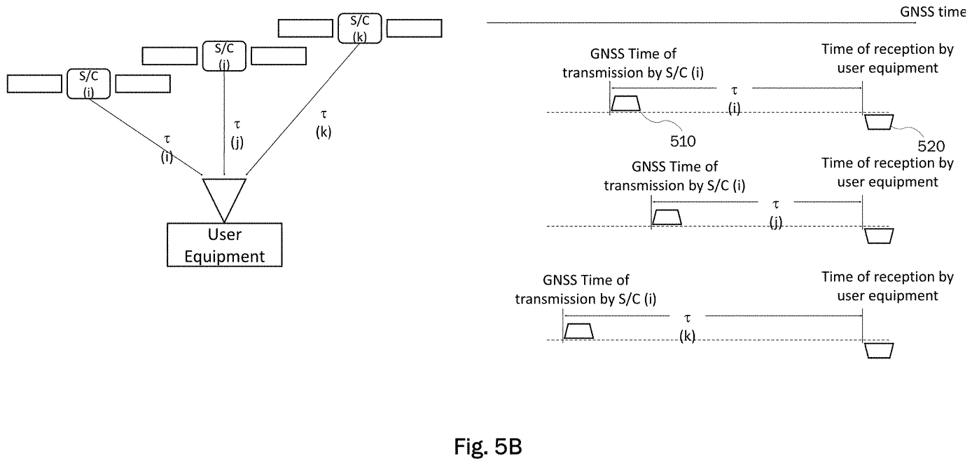

The TDD pattern can be synchronized on the same GNSS epoch across several LEO-PNT satellites or across all the LEO-PNT satellites. This means that the transmitted navigation signals from different LEO-PNT satellites will not reach the user on ground at the same time because of the spread in propagation time from the various satellites to the user. An example of such situation is schematically shown in FIG. 5A, where each line relates to a different payload and shows a transmission time slot 510 in which the navigation signal is transmitted, and a corresponding time slot 520 in which this navigation signal (originating from the transmission time slot 510) is received at a given UE. In this example, the TDD transmission time slots 510 at the different payloads are synchronized, but time slots 520 in which respective navigation signals transmitted in transmission time slots 510 by the different (spatially separated) payloads are received at the UE will be spread over time. This approach can be advantageously implemented to spread the transmitted power over time, and therefore to reduce the Equivalent Power Flux Density (EPFD) levels of signals received on Earth, and therefore facilitate the compliance to ITU regulations.

The TDD pattern can be synchronized across several satellites of the LEO-PNT constellation with a specific timing offset, determined in such way that the signals from the various satellites would reach the user equipment in certain regions on Earth at the same time. An example of such situation is schematically shown in FIG. 5B, in which TDD transmission time slots 510 at the different payloads are spread over time in accordance with timing offsets (e.g., delays) determined in accordance with respective relative distances between the payloads and a UE or UE region of interest, but time slots 520 in which respective navigation signals transmitted in transmission time slots 510 by the different payloads are received will be aligned for the UE of interest. This approach can be advantageously implemented to allow the receiver to switch on the front-end only at certain epoch, when the signals are expected to be received.

The LEO-PNT payloads may use the information derived from their onboard Orbit Determination to determine the time offset to apply to the TDD pattern in order to align the signals at receiver level in a predefined area or region on Earth. To switch on at the epoch where the LEO-PNT signals are expected, the user equipment needs to estimate the propagation time from the LEO-PNT payloads to its position. On the other hand, the LEO-PNT payloads may use the information derived from their onboard Orbit Determination to determine the time offset to apply to the TDD pattern in order to align the signals at receiver level in a predefined area or region on Earth.

### Reception of GNSS Signals and Messages Received in TDD Mode

GNSS and SBAS signals (or higher-orbit satellite navigation or augmentation signals in general) are designed for continuous transmission, assuming also continuous reception by, for example, the user equipment. The same consideration applies to the physical layer of the data content of these signals. Duty-cycled reception of these signals may affect the stability of algorithms used as well as the quality of measurements made (e.g., accuracy, reliability/integrity, etc.). This may be of particular importance for the GNSS receiver of the LEO-PNT payload, as its purpose is to deliver information supporting accurate and trustworthy ODTS for the payload and LEO-PNT signals.

Switching off the reception of the signal in the analog domain, to protect the RF front-end, may not be sufficient to avoid any impairment. It may also be necessary to force the digital signal at the input of the baseband processing state (e.g., digital down conversion, carrier removal and correlators of the GNSS signals, etc.) to zero during the time internal when the reception (of the GNSS signal) is off and the transmission (of the navigation signal) is active. Means for achieving such blanking may be generally in place in GNSS receivers, which are configured for example to protect the GNSS reception from the effects of pulse Distance Measuring Equipment (DME) signals in the E5 band. Nevertheless, such blanking is typically implemented with blanking duration shorter than the Pseudo Random Noise (PRN) code period and symbol period of the messages, thus does not require specific optimization of the acquisition and tracking algorithms nor of the message demodulation and decoding.

In some implementations, the LEO-PNT payload may operate with a duty-cycling period longer than that of the typical GNSS PRN period and/or symbols duration, and therefore the algorithms to receive the GNSS signals in TDD mode during this duty-cycling operations may need further adaptation to limit impairments on the effective SNR, as well as on the accuracy, quality, and integrity of the measurements, and to keep performance at a good level for accurate and trustworthy algorithms, as the skilled person will appreciate.

Typical acquisition (e.g., search engine and matched filter involved in acquisition of the signals) and tracking algorithms (e.g., Delay-Locked Loop (DLL), Frequency-Locked Loop (FLL), Phase-Locked Loop (PLL)) assume continuous reception of the GNSS signals, and therefore assume that each sample in baseband contains relevant information about the GNSS signals. This may not be the case for signals received in TDD mode as the samples are blanked (forced to zero) during the transmission period of the payload. Adaptation and optimization of the algorithms of the GNSS receiver in the LEO-PNT payload may aim to accommodate and possibly compensate for this absence of information.

Using the exact knowledge of when the transmission is active and the reception needs to be switched off, the receiver can force all the samples of the digital baseband series to zero during the time interval equivalent to the transmission time interval of the payload. As these samples do not carry information, the receiver can also advantageously put the baseband processing on hold, such as correlation, Numerically Controlled Oscillator (NCO), etc. This may contribute to reducing power consumption at the payload.

The tracking algorithms may extrapolate their estimates during the blanking period of the TDD mode, taking advantage of the predictable signal's dynamics (e.g., range rate, etc.), due to the smooth trajectories of the GNSS and LEO satellites and the stable on-board clocks.

Accordingly, the method 200 described above may further include a step ensuring signal tracking of the GNSS signals in the TDD transmission periods during which the GNSS signals are blanked. For example, step S630 of the method 600 of FIG. 6 (as part of the method 200) may be a step of maintaining signal tracking of the GNSS signal(s) during time slots for transmitting the navigation signal to avoid re-acquisition, based on a result of the at least one of orbit determination or time synchronization. The purpose of step S630 is to avoid re-acquisition of the GNSS signal(s) tracking when transmission of the navigation signal stops and reception of the GNSS signal(s) resumes. In some implementations, step S630 may involve maintaining tracking algorithms within boundaries of lock indicators. Additionally or alternatively, step S630 may involve extrapolating tracking parameters and/or states to keep tracking loops to prevent the tracking loops to leave the pull-in range or loose lock during time slots when reception of the GNSS signal is interrupted and the navigation signal is transmitted.

In case that the LEO-PNT payload receives multiple GNSS frequencies from the same GNSS satellite, the payload may not blank all the signals at the same time and alternate the blanking among the frequencies incoming from the same GNSS satellite (e.g., reception of E1 while blanking E6, etc.). For example, it may be said that for each of the alternating time slots, reception in at least one GNSS frequency band is active to aid signal tracking of GNSS signals in other GNSS frequency bands in that time slot for which reception is not active. Examples of alternating blanking among different GNSS frequencies are given in Table 4, Table 5, and Table 6. The algorithms operating on a band A which is not blanked can aid the algorithms operating on a band B which is blanked while A is not, and reversely. The aiding information can be further adapted or adjusted, considering the different frequencies between A and B and their impact on Doppler, ionosphere, etc., as the skilled person will appreciate.

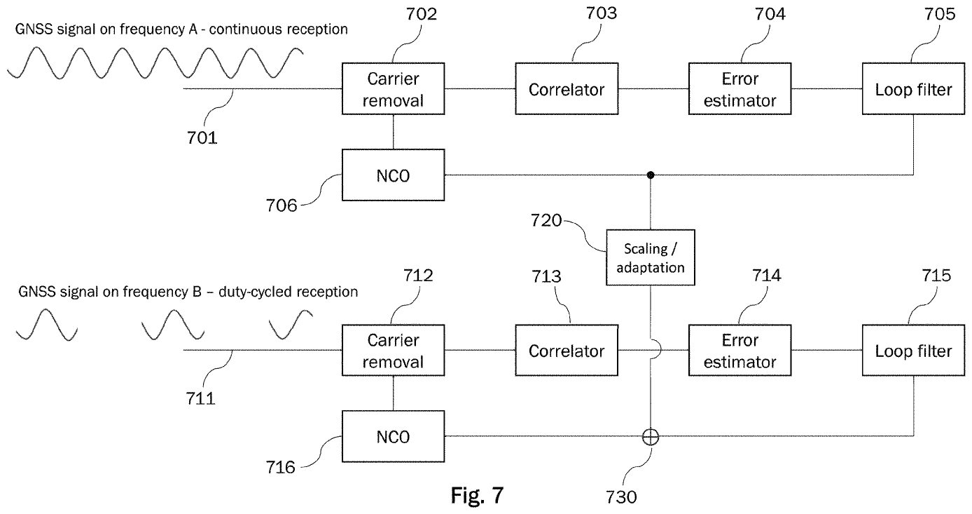

An example of how tracking algorithms can be aided by information from reception in another frequency band is schematically illustrated in FIG. 7. In this example, a first GNSS signal 701 is continuously received on frequency A and subjected to processing by a first processing loop, whereas a second GNSS signal 711 is received on frequency B in TDD mode (i.e., in duty-cycled reception) and subjected to processing by a second processing loop. Carrier removal is performed for both GNSS signals at respective carrier removal blocks 702, 712, based on outputs of respective NCOs 706, 716. After carrier removal, the resulting signals are fed to respective correlators 703, 713, subsequent to which error estimation is performed at respective error estimators 704, 714. After error estimation, the resulting signals are fed to respective loop filters 705, 715, outputs of which are provided to respective NCOs 706, 716, thus closing the first and second processing loops. For aiding signal tracking of the second GNSS signal, an output of the loop filter 705 of the first processing loop may also be provided to the NCO 716 of the second processing loop, after optional scaling and/or adaptation at scaling/adaptation block 720, via adder 730.

In addition, as described above for instance for step S630, the algorithms (e.g., in acquisition and in tracking) can be aided by information derived from the on-board ODTS (e.g., ODTS as performed at step S610). This works best with using the accurate onboard ODTS, but can also provide benefits if the accurate ODTS is not available or not yet available, and only a coarse ODTS estimate is available to the LEO-PNT payload (e.g., two line elements received by TC, long term extrapolation of ODTS, etc.). Aiding in this context may include, but is not limited to, aiding of the DLL, FLL, and/or PLL with range rate estimates from the ODTS and/or use of the prior knowledge of the time of arrival of the GNSS signals (e.g., to reduce search space in acquisition).

The demodulation, decoding and estimation of the bits contained in the GNSS signals received by the LEO-PNT payload in TDD mode may also be adapted and/or optimized to limit the degradation of performances resulting from the TDD mode on GNSS signals. The receiver may advantageously take benefit of the interleaving and channel coding of the GNSS signals (when present on those signals) and adapt the associated receiving algorithms to the TDD mode.

Good estimates of the carrier phase may be important for the demodulation of the data symbols. The output of the correlators or match filter output on the pilot and data components of modern GNSS signals may be combined together in a non-coherent demodulation (e.g., by using the output of pilot and data components prompt correlators) to complement or replace typical demodulation using the PLL, and wipe-off the residual carrier phase on the data symbols even if the PLL is not operating optimally because of TDD.

Interleaving and channel code of modern GNSS signals may significantly compensate the effects of blanking and absence of information on some samples. In particular, the decoding algorithms operating on the received symbols can be optimized to take into account the nature of the TDD and the fact that some symbols are forced to zero because of the TDD operation. The receiver can maintain soft-decision input to the decoder on the symbols received while the receiver is not blanked and enforce a hard-decision input to the decoder on the symbols received during the blanking.

To fully benefit from the interleaving and decoding mechanism embedded in modern GNSS signals, it may be desirable to have a duty-cycling period shorter than the duration of the interleaving, or of the channel code block, and it may also be desirable to have the duty-cycling period shorter than the duration of the bits carried by the GNSS signals.

### High-Accuracy ODTS Using GNSS Signals and Data

Accurate ODTS of satellites can be derived in multiple ways currently in use in typical space systems, and in particular satellite navigation systems. One such methods may use measurements from GNSS signals possibly combined with PPP corrections broadcasted by, for example, Galileo HAS services.

Accordingly, the at least one of orbit determination or time synchronization (e.g., ODTS) performed at step S610 of the method 600 may be based on a high accuracy correction received with the GNSS signal, or received from the GNSS (as an example of a higher orbit navigation or augmentation system).

ODTS of the LEO-PNT satellites can be performed in real-time by the On-Board Computer (OBC) running for instance a reduced-dynamic orbital filter processing GNSS measurements. The reduced-dynamic orbital filter of the ODTS models the most significant forces acting on the satellite (e.g., Earth gravitational model, Sun and Moon gravitational models, atmospheric drag, solar radiation pressure, etc.). The ODTS can use a real-time Precise On-board Orbit Determination (P2OD) algorithm using both pseudo-range and carrier phase measurements with floating ambiguities or with Integer Ambiguity Resolution (IAR) capabilities.

The LEO-PNT signals (or in general, navigation signals in the context of the present disclosure) may therefore be disciplined and referenced to an ODTS computed in real time or close to real time onboard involving information combining the broadcast GNSS navigation message, and for example Precise products of the Galileo High Accuracy Service (HAS) received from Galileo E6B.

Nonetheless, in addition to the corrections and data delivered by the HAS, the exploitation of multiple sources of range/range rate measurements (e.g., multi-GNSS, ISR, TTC measurements) and data/corrections when available may improve the availability of the system against outages of some of these sources.

When the on-board GNSS receiver processes a GNSS signal from a given GNSS in single-frequency mode, and both pseudo-range and carrier phase measurements are available, GRAPHIC combination can be used to remove the ionosphere contribution. When a GNSS signal from a given GNSS is tracked in single-frequency mode and only pseudo-range measurements are available, ionospheric corrections can be used, and if necessary, further adapted to the LEO altitude. Given the fact that there is still only a residual ionosphere above LEO-PNT satellites (compared to the complete ionosphere for terrestrial users), profiler ionosphere models (e.g., NeQuikG) can achieve better performances.

The ODTS process may use different weightings for different measurements from different sources (e.g., frequency, satellites) and based on the data/corrections used for each of them. These different weightings may account for different accuracies and may improve the performances of the ODTS solution, for instance, in terms of accuracy and/or of availability of the ODTS solution.

The estimates of orbit and clock of the LEO-PNT satellites resulting from the ODTS process on-board may be used to generate orbit and clock products in real-time or close to real time, to be disseminated to the LEO-PNT receivers via the data contained in the LEO-PNT signals (navigation signals). These products may be derived by applying curve fitting to the orbit and clock estimates, depending on the required validity of the resulting products (e.g., use of Keplerian elements, standard polynomials, B-spline, Chebyshev polynomials, and/or any variants of these).

### Trustworthiness of ODTS Information

The ODTS can implement integrity capabilities to determine whether the errors of GNSS measurements and/or the ODTS solution are within a given value with a given probability of missed detection.

Accordingly, the at least one of orbit determination or time synchronization (e.g., ODTS) performed at step S610 of the method 600 may use information about the integrity of the GNSS signal.

For instance, integrity capabilities of the ODTS can be implemented by using one or a combination of the following:
Exploitation of SBAS integrity data received by the on-board GNSS receiver or via a terrestrial network
Receiver Autonomous Integrity Monitoring (RAIM) techniques, exploiting the redundancy between GNSS measurements and possibly ISR measurements
Advanced Receiver Autonomous Integrity Monitoring (ARAIM) techniques, by receiving and processing Integrity Support Messages (ISM). The ISM emanates advantageously from GNSS or SBAS signals and systems instead of via additional links such as uplink TC or ISL.
Any of the above or the combination of several of the above in association with the aforementioned orbital filter/reduced dynamic orbital filter

Alternatively or additionally, the at least one of orbit determination or time synchronization (e.g., ODTS) performed at step S610 of the method 600 may use information about the authenticity of the GNSS signal.

For example, the ODTS process may implement authentication capabilities exploiting one or more of:
Authentication features carried by GNSS signals such as Navigation Message Authentication and encrypted signals (e.g., OSNMA and CAS of Galileo, Chimera of GPS),
Processing the baseband signals to assess the consistency of the correlation functions, and performing consistency check of the status of the baseband processing functions, their raw measurements (code, carrier phase, Doppler, signal to noise ratio, etc.),
Processing of GNSS signals received on two or more antennas to detect inconsistency in angle of arrival/angle of arrival signature. The reception of several antennas can be performed simultaneously, and intermittently, for instance switching among the antennas with a certain duty cycle.
Any combination of the above

The aforementioned technique(s) can operate continuously or intermittently, in order to reduce processing complexity and computation power. For instance, the processing of the encrypted signals can be performed with duty-cycling, on snapshot of a certain duration (e.g., up to tens of ms), or every longer period up to several seconds or tens of seconds.

Furthermore, the aforementioned processing can be advantageously combined with the orbital filter or reduced dynamic orbital filter, and leverage the short term stability of the onboard clock (e.g., oven controlled crystal oscillator, chip-scale atomic clock, miniature atomic clock) to improve the statistics of the consistency check, or to coast a trustworthy solution during the above duty-cycling and the time when no processing of the trustworthiness is performed.

The resulting information, indicators about trustworthiness of the ODTS solution and the trustworthiness of the reference of the LEO-PNT signals to the ODTS, may then be communicated to the user equipment via the data contained in the LEO-PNT signals (navigation signals).

In any case, the at least one of orbit determination or time synchronization (e.g., ODTS) performed at step S610 may be based on one or more of:
an SBAS message received with the GNSS signal;
ranging authentication and/or message authentication of the GNSS signal;
an HAS message received with the GNSS signal; and/or
an ISM message received with the GNSS signal.

### Relay of Navigation-Related Data

The relay of GNSS messages (or GNSS content in general) onto LEO-PNT signals (or navigation signals as transmitted at step S220 of method 200 in general) comprises retrieving the specific message from the fields and pages of the relevant data component of the GNSS signal, and introduce them, in real-time or with delay, into fields and pages of the data component of the transmitted LEO-PNT signals. Different methods for performing the relay may be considered and tailored to using the TDD mode.

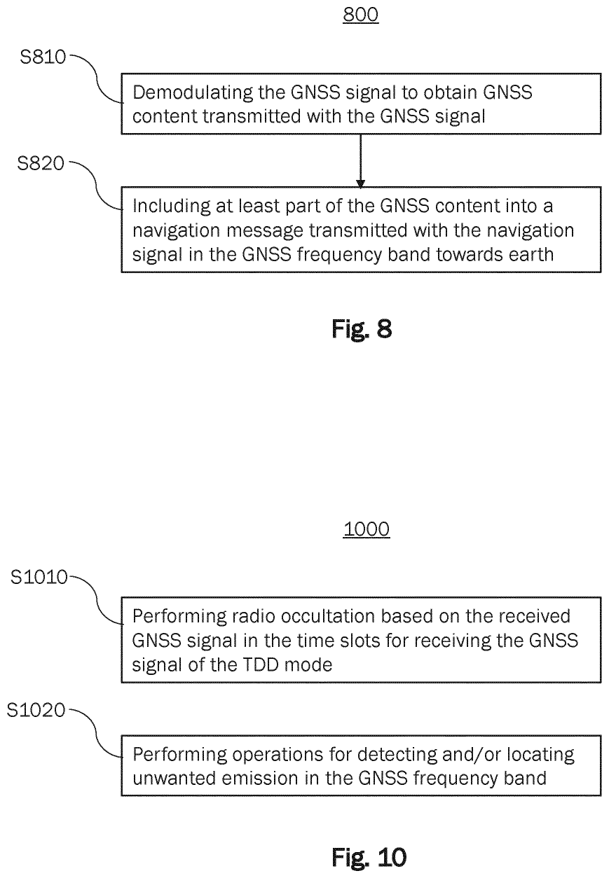

Accordingly, the method 200 described above may further include one or more of the steps of method 800, which will now be described with reference to the flowchart of FIG. 8. Method 800 comprises steps S810 and S820, both of which may be optional steps for the method 200 described above. Also these steps may be performed continuously.

At step S810, the GNSS signal (e.g., received at step S210) or a GNSS message contained therein is demodulated to obtain GNSS content transmitted with the GNSS signal. The GNSS content obtained in this manner may relate to one or more (low latency) GNSS messages, for example.

At step S820, at least part of the GNSS content is included into a navigation message transmitted with the navigation signal in the GNSS frequency band towards Earth. Thus, the payload may be said to relay the GNSS content to any receivers of the navigation signal.

Therein, the GNSS content obtained at step S810 and relayed at step S820 may relate to one or more of:
a SBAS message;
a SAR return link message;
an integrity support message (ISM);
a high accuracy service (HAS) message;
an emergency warning message; and/or
an authentication message.

In case the duty-cycling period is shorter than the period of the received symbols, the LEO-PNT payload may estimate each symbol of the data component of the received GNSS signals, and introduce the associated value directly as a symbol of a data component of a LEO-PNT signal. This imposes to by-pass the decoding, and may impose a hard-decision on the received symbols, which might result in sub-optimal estimation performances, but will minimize the latency of the relay mechanisms of the LEO-PNT payload.

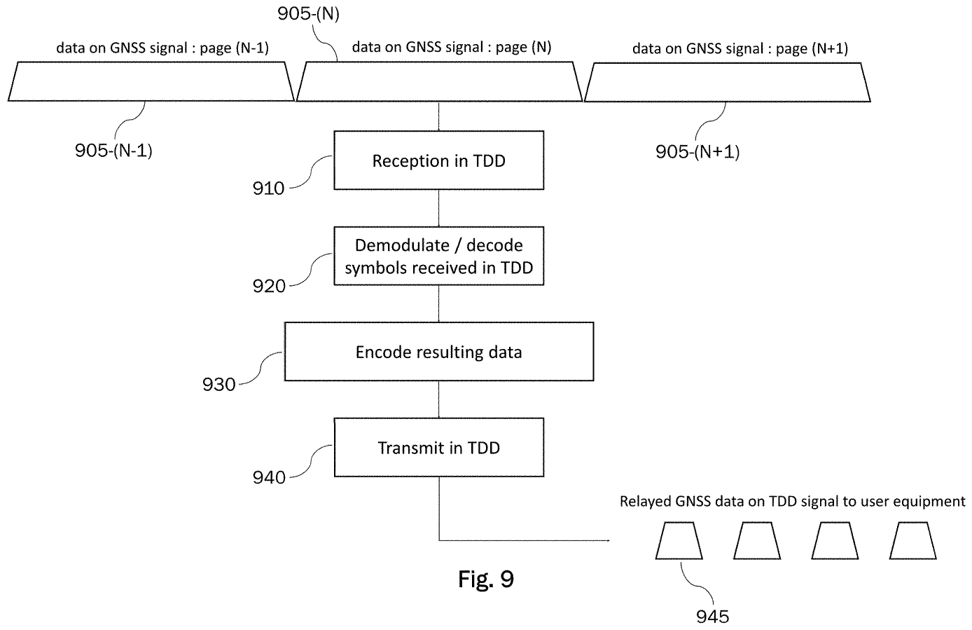

More advantageously, the LEO-PNT payload can decode and estimate all or part of the pages of the received GNSS signals in TDD mode, select the pages, fields and bits to be relayed, and encode and introduce them as symbols of a data component of a LEO-PNT signal. An example of such procedure is schematically illustrated in the block diagram of FIG. 9, where the horizontal axis indicates time with respect to GNSS signal pages 905-(N−1), 905-N, 905-(N+1), etc. After reception of a respective page at reception block 910, it is demodulated at demodulator block 920 and the symbols thereof are decoded. The resulting data is encoded at encoding block 930 and transmitted in TDD mode with the navigation signal at transmission block 940 in a sequence of TDD time slots 945.

Doing so, the LEO-PNT payload may keep any of the formatting, encoding, interleaving, bits and symbol rate used by the incoming GNSS signals, or implement a different translation of the bits into symbols of a data component. For instance, the channel code, redundancy ratio of the channel code, and rates of the data on the LEO-PNT signal could be modified and optimized to the nature of the LEO signals. The data or the symbol rate could be increased leveraging a higher signal-to-noise ratio of LEO signals, to accelerate the dissemination of the associated data to the users, and reduce the end-to-end latency compared to the case where the rate of the GNSS signals would be used.

### Ancillary Capabilities

The design of the receiver and instruments processing GNSS signals involved in radio-occultation (GNSS-RO), reflectometry (GNSS-R) and GNSS interference monitoring from space (RFI monitoring) assume that the signals are continuously received during the time that the occultation or reflection last.

This assumption does not stand for the GNSS-RO, GNSS-R and RFI signals received by the LEO-PNT payload which would include those function in addition to the transmission of LEO-PNT signals in TDD mode. Like for the reception of GNSS signals for ODTS, the algorithms of GNSS-RO, GNSS-R and RFI monitoring functions need to be tailored to TDD to limit impairments and performance degradation.

Typical solutions for GNSS-RO, GNSS-R and RFI monitoring may be similar to the algorithms described above for the signals received for ODTS, such as aiding among channels and frequency bands, aiding by the ODTS information, and assuming a coarse knowledge of the position of the source (e.g., occulted GNSS satellite, etc.).

Accordingly, the method 200 described above may further include one or more of the steps of method 1000, which will now be described with reference to the flowchart of FIG. 10. Method 1000 comprises steps S1010 or S1020, both of which may be optional steps for the method 200 described above and may be performed independently of each other. Also these steps may be performed continuously.

At step S1010, radio occultation is performed based on the received GNSS signal in the time slots for receiving the GNSS signal of the TDD mode.

At step S1020, operations for detecting and/or locating unwanted emission in the GNSS frequency band are performed. Here, locating unwanted emission may involve multilateration using multiple satellite payloads. Further, this step may involve or correspond to, for example, performing radio interference (RFI) estimation in the time slots for receiving the GNSS signal of the TDD mode.

FIG. 11 schematically illustrates an example of a framework for performing RO (e.g., via step S1010) according to embodiments of the disclosure. In this framework, a LEO-PNT satellite 1120 receives a signal (e.g., GNSS signal) transmitted by a GNSS satellite 1120 after the signal's passage through Earth's ionosphere 1130. The received GNSS signal(s) can be used for inferring information on a state of the ionosphere 1130.

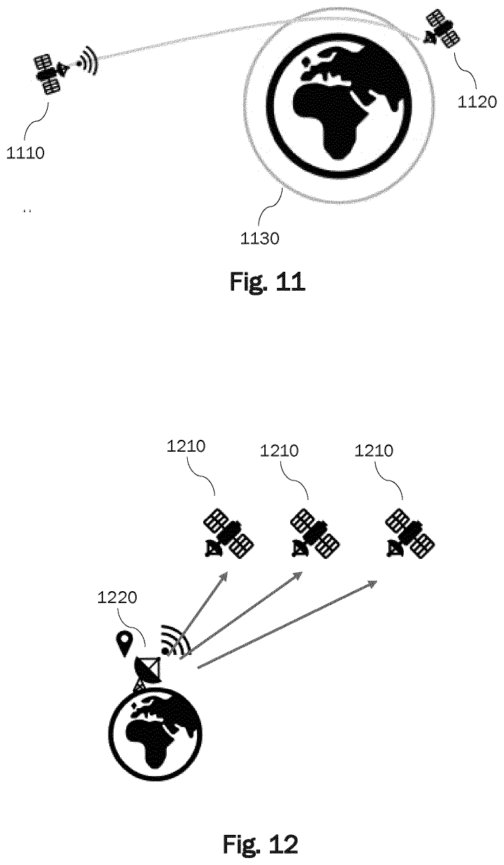

FIG. 12 schematically illustrates an example of a framework for performing RFI estimation (e.g., via step S1020) according to embodiments of the disclosure. In this framework, one or more LEO-PNT satellites 1210 receive signals from ground (e.g., ground-based emitter 1220) in a GNSS frequency band and estimate RFI and/or locate a source of interference (e.g., via multilateration).

### Signal Design and Generation

The design of the LEO-PNT is intended and/or optimized for enable the user equipment to derive relevant (e.g., optimal) positioning-velocity-timing related measurements from the navigation signals. It is further intended and/or optimized to disseminate data relating to ODTS, its trustworthiness, as well as additional data, some of them originating from external sources, to the user equipment. Each of the LEO-PNT signals (navigation signals) can be composed of multiple signal components including but not limited to:
One or more data components, which are modulated by the navigation message
One or more pilot components, which is not modulated by the navigation message
One or more quasi-pilot components, which deviates from a pure pilot with low entropy information
Optionally, intermodulation components if Constant Envelope Modulation (CEM) multiplexing is used.

LEO-PNT signal generation can be fully digital, exploiting for instance technologies and architectures of Software-Defined Radio (SDR) to allow for upgrades of software and firmware once in orbit. This can allow the update of the LEO-PNT signal characteristics in space during system life-time, and even addition of new signals, for example.

In the cases in which a LEO-PNT signal is composed of multiple signal components, they can be linearly multiplexed (e.g., simply added together) or multiplexed using techniques to reduce the Peak-Average Power Ratio (PAPR) at the input of the payload's High Power Amplifier (HPA) in the transmission chain.

One or more of the LEO-PNT signal components can include time dissemination features allowing for the dissemination of absolute time (e.g., Time of Week) and/or resolving time uncertainties (e.g., after using time aiding data). The sizing of the signal and time synchronization mechanisms can leverage the shorter distance to LEO to feature shorter codes (e.g., a 10 ms code would allow solving the ambiguity for a slant range up to 3000 km), which are easier to acquire/detect/synchronize.

The LEO-PNT signal can be designed for various multiple access schemes on the downlink and/or the uplink. While CDMA-DSSS is widely adopted for GNSS and may be very suitable for LEO PNT signals, alternative schemes, or their combination (e.g., FDMA+DSSS) may also be considered (e.g., to facilitate acquisition and use for asset tracking, noting that shorter PRN/narrow band signals are more attractive, and for those, FDMA could outperform CDMA). The LEO-PNT signals can use Direct Sequence Spread Spectrum (DSSS) or Chirp Spread Spectrum (CSS) to optimally spread the signals in the allocated bandwidth, and to optimize the complexity of the processing in the user equipment for the allocated bandwidth and sampling frequency (e.g., reduced complexity for the acquisition and tracking, improved synchronization, and ranging performances).

The LEO-PNT broadcast signal can also make use of bandwidth-efficient modulations like Continuous Phase Modulation (CPM) to reduce the out-of-band emissions and improve spectrum compatibility with signals in adjacent bands.

The LEO-PNT signals can include cryptographic features to ensure the authenticity of the broadcast navigation message and the ranging code, or support the control of the access to the corresponding service, or a combination of both.

The LEO-PNT signal can carry a data message protected by error control coding and/or erasure coding techniques with and without bit interleaving.

The LEO-PNT constellation can implement spatial diversity techniques, for instance among multiple satellites, to improve the capacity or to improve the availability to the user equipment for the dissemination of data messages.

### Integration of 2-Way Signaling for PNT

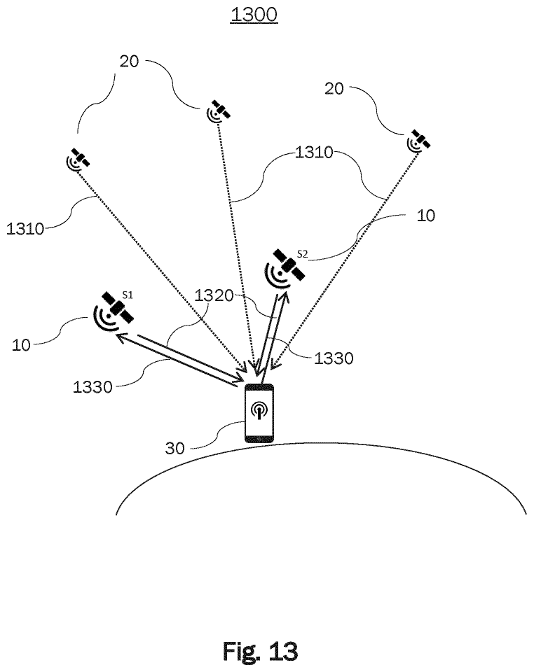

An example framework 1300 for integrating 2-way signaling between one or more LEO payloads and one or more pieces of user equipment (UEs) is schematically illustrated in FIG. 13. This framework comprises a set of GNSS satellites 20 (e.g., in MEO), a UE 30, a set of payloads hosted on satellites 10, for example in LEO.

Two-way exchange in this framework may involve signal items (1), (2), and (3) described below.
(1): At least one of
   One or more GNSS satellites 20 transmit GNSS navigation signals 1310 that are received by the UE 30
   One or more payloads transmit navigation signals 1320 in TDD and/or FDD mode that are received by the UE 30
   Depending and/or prompted by the received signal, the UE 30 composes an uplink message 1330 and transmits said uplink message 1330 to one or more payloads that receive the uplink signal 1330 in TDD and/or FDD mode
(2): The uplink signal 1330 is received by the payload in TDD and/or FDD mode to provide two-way PNT services to the user, for example one or more of:
   a time transfer between two UEs
   time bounding
   position bounding
   payload-based position validation
(3): If for providing the two-way PNT services the data from more than one payload is required, the information received at multiple payloads may be fused and processed (not shown in FIG. 13) in at least one of:
   one of the payloads (e.g., through ISLs or via a ground station)
   a ground station
   the UE 30 through an additional downlink in TDD and/or FDD mode

Accordingly, the method 200 described above may further include an optional step of receiving an uplink signal from user equipment for two-way navigation services, for example with two-way navigation services relating to one or more of: a time transfer between the user equipment and the payload; a time transfer between the user equipment and another user equipment; bounding of the time of the user equipment; bounding of the position of the user equipment; and/or verification of the position of the user equipment by the payload.

Therein, the composition of the uplink signal 1330 may depend on prior reception of a downlink navigation message 1310, 1320 by one or more of: a signal from the payload; a signal from another payload; and/or a GNSS signal.

### FURTHER IMPLEMENTATION EXAMPLES

As noted above, a payload according to embodiments of the present disclosure may be a satellite payload, such as a payload aboard a satellite in LEO, or LEO-PNT satellite, for example.

In other implementations, multiple payloads may be provided and distributed across several spacecraft. For example, the payloads may be distributed across spacecraft (e.g., satellites) in a layer of a multi-layer satellite navigation system. The multi-layer satellite navigation system may include one or more satellites in MEO, one or more satellites in LEO, and/or one or more satellites in GEO. The multiple payloads may be provided for example in (or across) a layer of the multi-layer satellite navigation system, each payload provided at a respective one among the satellites in LEO.

While exemplary reference has been made to a LEO-PNT payload, the present disclosure relates to any payload (e.g., satellite payload, distributed payload) with the required capabilities (e.g., receive capability, transmit capability, and possibly processing capability for the purpose of providing PNT functions). Such payload is understood to be configured to perform any or all of the methods described above.

Moreover, the present disclosure likewise relates to satellites (e.g., LEO satellites, LEO-PNT satellites) comprising the aforementioned payload (e.g., satellite payload).

### INTERPRETATION

It is understood that any modules, units, or blocks described above may be implemented by a computer processor or respective computer processors, or the like. Modules, units or blocks described above may further be implemented in a cloud-based manner.

It should further be noted that the description and drawings merely illustrate the principles of the proposed method and system. Those skilled in the art will be able to implement various arrangements that, although not explicitly described or shown herein, embody the principles of the disclosure and are included within its spirit and scope. Furthermore, all examples and embodiment outlined in the present document are principally intended expressly to be only for explanatory purposes to help the reader in understanding the principles of the proposed method and system. Furthermore, all statements herein providing principles, aspects, and embodiments of the disclosure, as well as specific examples thereof, are intended to encompass equivalents thereof.

With regard to the flowcharts described throughout the present disclosure, it is to be understood that the order of steps is not necessarily fixed by the flowchart; rather, steps may be performed in any order or even in parallel, provided that any input to these steps from other steps is available.

### Enumerated Example Embodiments

Aspects and implementations of the present disclosure may also be appreciated from the following enumerated example embodiments (EEEs), which are not claims.
EEE1. A method of satellite-based positioning, the method comprising:
   receiving, by a radio receiver, a navigation signal in a GNSS frequency band;
   determining a position of the radio receiver based on the navigation signal,
   wherein receiving the navigation signal is performed in a time division duplex, TDD, mode, with alternating time slots in which the navigation signal is present or absent, respectively.
EEE2. The method according to EEE1, wherein the navigation signal is a non-GNSS navigation signal.
EEE3. The method according to EEE1 or EEE2, wherein the navigation signal is a LEO-PNT signal.
EEE4. The method according to any one of the preceding EEEs, wherein the navigation signal is a navigation signal for code-based ranging measurements, carrier-based measurements, and/or Doppler measurements at a receiver and/or low complexity acquisition at the receiver.
EEE5. The method according to any one of the preceding EEEs, further comprising:
   receiving, by the radio receiver, GNSS signal(s) from a GNSS in the GNSS frequency band,
   wherein determining the position of the radio receiver is further based on the GNSS signal.
EEE6. The method according to EEE5, wherein the GNSS frequency band is one of bands E1, E6, E5, E5a, E5b as defined for Galileo or one of L1 through L5 as defined for GPS.
EEE9. The method according to EEE5 or any claim dependent on EEE5, further comprising:
   demodulating the navigation signal; and
   extracting GNSS content from the demodulated navigation signal,
   wherein determining the position of the radio receiver is further based on the extracted GNSS content.
EEE10. The method according to EEE9, wherein the GNSS content relates to a high accuracy correction.
EEE13. A computer program for causing a computer coupled to a radio receiver, when executed by the computer, to perform the method according to any one of the preceding EEEs.
EEE14. A non-transitory computer-readable storage medium storing the computer program according to EEE13.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method of operating a satellite payload with receive and transmit capabilities in Earth orbit, the method comprising:
receiving a Global Navigation Satellite Systems (GNSS) signal from a GNSS in a GNSS frequency band; and
transmitting a navigation signal in the GNSS frequency band towards Earth,
wherein the receiving and transmitting are performed in a time division duplex (TDD), mode, with alternating time slots for receiving the GNSS signal and transmitting the navigation signal.

2. The method according to claim 1, wherein a duty cycle of the TDD mode is synchronized with timing epochs of the GNSS.

3. The method according to claim 2, further comprising:
performing at least one of orbit determination or time synchronization for the satellite payload based on the GNSS signal.

4. The method according to claim 3, wherein synchronization of the duty cycle of the TDD mode to the timing epochs of the GNSS is performed based on a result of the at least one of orbit determination or time synchronization.

5. The method according to claim 3, wherein the at least one of orbit determination or time synchronization is based on a high accuracy correction received with the GNSS signal.

6. The method according to claim 3, wherein the at least one of orbit determination or time synchronization uses information about an authenticity of the GNSS signal.

7. The method according to claim 3, wherein the at least one of orbit determination or time synchronization uses information about an integrity of the GNSS signal.

8. The method according to claim 3, wherein the at least one of orbit determination or time synchronization is based on one or more of:
a Space Based Augmentation Systems (SBAS) message received with the GNSS signal;
ranging authentication and/or message authentication of the GNSS signal;
a High Accuracy Service (HAS) message received with the GNSS signal; and/or
an Integrity Support Message (ISM) message received with the GNSS signal.

9. The method according to claim 3, further comprising:
maintaining signal tracking of the GNSS signal during time slots for transmitting the navigation signal to avoid loss of lock and/or re-acquisition, based on a result of the at least one of orbit determination or time synchronization.

10. The method according to claim 1, further comprising:
demodulating the GNSS signal to obtain GNSS content transmitted with the GNSS signal; and
including at least part of the GNSS content into a navigation message transmitted with the navigation signal in the GNSS frequency band towards Earth.

11. The method according to claim 10, wherein the GNSS content relates to one or more of:
a space-based augmentation systems (SBAS) message;
a synthetic aperture radar (SAR) return link message;
an integrity support message (ISM);
a high accuracy service (HAS) message;
an emergency warning message; and/or
an authentication message.

12. The method according to claim 1, wherein the navigation signal is a first navigation signal transmitted in a first GNSS frequency band towards Earth, the method further comprising:
transmitting a second navigation signal towards Earth in a second GNSS frequency band different from the first GNSS frequency band or in a non-GNSS frequency band, in frequency division duplex (FDD) mode.

13. The method according to claim 1, further comprising:
performing radio occultation based on the received GNSS signal in the time slots for receiving the GNSS signal of the TDD mode.

14. The method according to claim 1, further comprising:
performing reflectometry based on the received GNSS signal in the time slots for receiving the GNSS signal of the TDD mode.

15. The method according to claim 1, further comprising:
performing operations for detecting and/or locating unwanted emission in the GNSS frequency band in the time slots for receiving the GNSS signal of the TDD mode.

16. The method according to claim 1, further comprising:
performing radio interference estimation in the time slots for receiving the GNSS signal of the TDD mode.

17. The method according to claim 1, wherein the navigation signal is a navigation signal for one or more of code-based ranging measurements, carrier-based measurements, and Doppler measurements at a receiver and/or low complexity acquisition at the receiver.

18. The method according to claim 1, further comprising:
receiving an uplink signal from user equipment for two-way navigation services, wherein the two-way navigation services relate to one or more of:
a time transfer between the user equipment and the satellite payload;
a time transfer between the user equipment and another user equipment;
bounding of the time of the user equipment;
bounding of the position of the user equipment; and/or
verification of the position of the user equipment by the satellite payload.

19. The method according to claim 1, wherein the satellite payload is a satellite payload aboard a satellite in low Earth orbit (LEO).

20. The method according to claim 1, wherein multiple satellite payloads are provided in respective spacecrafts in one or more layers of a multi-layer satellite navigation system.

21. The method according to claim 18, wherein a composition of the uplink signal depends on prior reception of a downlink navigation message by one or more of:
a signal from the satellite payload;
a signal from another satellite payload; and/or
a GNSS signal.

22. The method according to claim 1, wherein the GNSS frequency band is one of bands E1, E6, E5, E5a, and E5b as defined for Galileo or one of L1, L2 and L5 as defined for GPS.

23. A satellite payload with receive and transmit capabilities, wherein the satellite payload is configured to perform the method according to claim 1.

24. A satellite comprising the satellite payload according to claim 23.

25. A satellite navigation system comprising one or more satellite payloads according to claim 23.
